(19) United States
(12) Patent Application Publication
(10) Pub. No.: US 2025/0219966 A1
(43) Pub. Date: Jul. 3, 2025

(54) Apparatus For High-Speed Data Transfer

(71) Applicant: Zettar, Inc., Dover, DE (US)

(72) Inventor: Chin Fang, Mountain View, CA (US)

(21) Appl. No.: 18/989,467

(22) Filed: Dec. 20, 2024

Related U.S. Application Data
(60) Provisional application No. 63/616,864, filed on Jan. 2, 2024.

(51) Int. Cl. H04L 49/351; G06F 13/42; H04L 49/40

(52) U.S. Cl. CPC H04L 49/352; G06F 13/4221; H04L 49/40; G06F 2213/0026

(57) ABSTRACT

An architecture for high-speed data transfer in excess of 50 Gb per second streamlines data transfer by interconnecting a burst buffer of solid-state drives with data processing units through a high-speed Internet backbone avoiding internal computer bottlenecks and operating system delays.

### CROSS REFERENCE TO RELATED APPLICATION

This application claims the benefit of U.S. provisional application 63/616,864 filed Jan. 2, 2024 and hereby incorporated by reference.

### STATEMENT REGARDING FEDERALLY SPONSORED RESEARCH OR DEVELOPMENT

[symbol]

### BACKGROUND OF THE INVENTION

The present invention relates to computer architectures for data transmission over a network and, in particular, to an architecture capable of extremely high-speed data transfer over the Internet (specifically, a purposely provisioned high bandwidth network such as the U.S. Department of Energy (DOE)'s User Facility, Energy Sciences Network (ESnet), which has segments that provides bandwidth of 800 Gbps or faster).

Many important industries and research endeavors require the transfer or sharing of extremely large amounts of data, for example, on the order of a Petabyte, between remote locations. As one example, the Linac Coherent Light Source II (LCLS II), a high-energy x-ray laser for atomic research, is expected to require data transfers of multiple terabits per second. At typical Internet speeds of 100 Mb per second, the transmission of a terabit would require over 10 days. For these purposes, high-speed transmission rates in excess of 50 Gb per second or higher are desirable.

Standard computer architectures can easily handle network transmissions below these rates, but at higher transmission speeds such architectures can encounter significant bottlenecks, resulting from the complex interaction of computer hardware, the various hardware, processor scheduling and NUMA topologies, inefficient data transfer protocols, delays imposed by the operating system, for example, in task switching, and data traffic throttling caused by firewalls. Addressing these bottlenecks is difficult and accordingly, extremely high-speed data transfer is envisioned to require the design of new, and specialized components that are optimized collectively to address the aforementioned bottlenecks.

### SUMMARY OF THE INVENTION

The present inventor has recognized that standard, commercially available computer hardware can be enlisted to provide extremely high-transmission data rates by minimizing the path of dataflow within a standard computer architecture/operating system, and instead employing a high-speed ethernet switch for joining the various components independently and outside of this architecture/operating system. In this approach, a burst buffer of multiple solid-state drives is preloaded with data through a firewall at low speed using the conventional architecture/operating system. Data from the burst buffer is then output to protocol-capable Internet interfaces using the high-speed ethernet switch. The high-speed ethernet connection and protocol-capable Internet interfaces operate together to provide parallel, and thus scalable, high-speed communication with the Internet.

More specifically, in one embodiment, the invention provides an architecture using an ethernet switch communicating between the Internet, at least one network processor, and an ethernet interface. A processor communicates with multiple solid-state drives and works together with the ethernet interface and the network processors to execute a stored program to: (a) receive data from a production server through the ethernet interface and via the processor for storage in the solid-state drives at a first data rate; (b) transmit the data from the solid-state drives through the processor and ethernet interface to the ethernet switch for receipt by the network processors; and (c) transmit from the network processors to the Internet at a second data rate greater than the first dated rate and in excess of 50 Gb per second.

It is thus a feature of at least one embodiment of the invention to make use of commercially available computer hardware for high-speed data transmission by minimizing intracomputer data pathways, processor burden, and operating system involvement. During data transmission, the processor is dedicated to a simple task of streaming buffer data to a high-speed ethernet switch which is then used to connect with dedicated data processing units.

The bank may include at least two network processors each communicating with the ethernet switch for simultaneous transmission to the Internet to provide the data rate.

It is thus a feature of at least one embodiment of the invention to provide the ability for scaling through multiple channels provided by multiple network processors, simplified by the ability to join these elements with an ethernet switch.

The solid-state drives may have a capacity of at least 500 GB and may in some embodiments receive data using the NVMe protocol over a Peripheral Component Interconnect Express (PCIe) bus.

It is thus a feature of at least one embodiment of the invention to provide an extremely fast burst buffer for high data transmission rates and of large quantities of data that can be flexibly loaded at lower speeds using a standard CPU.

The communication between the ethernet interface and the processor and the ethernet interface and the ethernet switch may employ the Network File System (NFS) protocol.

It is thus a feature of at least one embodiment of the invention to allow transfer of data using the ethernet and a high-speed ethernet switch.

The architecture may further include a firewall, and the production server and the processor and ethernet interface may further operate to execute the stored program to receive the data via the firewall from the production server over ethernet.

It is us a feature of at least one embodiment of the invention to provide a high-speed data transfer architecture that can work with the reality of an interposed firewall necessary to protect the system against malware but necessarily providing a transmission bottleneck.

These particular objects and advantages may apply to only some embodiments falling within the claims and thus do not define the scope of the invention.

### BRIEF DESCRIPTION OF THE DRAWINGS

FIG. 1 is a simplified diagram of a system for transferring large amounts of data over long-distance Internet connections showing, at each end, production servers holding data communicated through a firewall with a high-speed data transfer appliance;

FIG. 2 is a phantom view of the principal components of a rackmount data transfer appliance per FIG. 1 showing a standard computer architecture providing a motherboard, a CPU with one or more cores, and expansion slots holding SSD drives and DPU cards, the standard computer architecture further communicating with a separate high-speed ethernet switch;

FIG. 3 is a block diagram of the components of FIG. 2 showing data flow paths implemented by a cooperation of these components coordinated by the CPU and the program executed thereon; and

FIG. 4 is a flowchart of the principle steps of a high-speed data transfer implemented by the program executed on the CPU, ethernet switch, and DPU cards.

### DETAILED DESCRIPTION OF THE PREFERRED EMBODIMENT

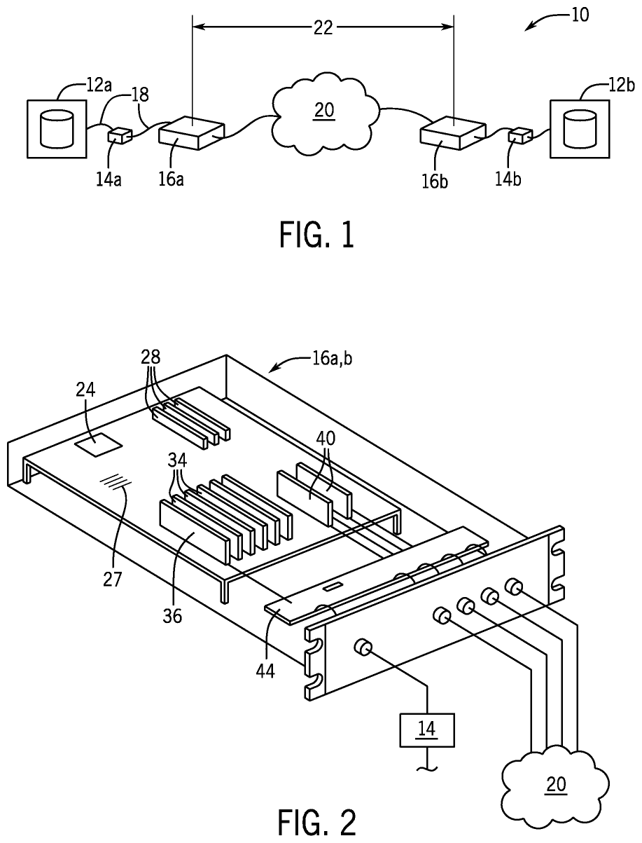

Referring now to FIG. 1, a system 10 for high-speed data transfer may provide a production server 12a, for example, consisting of a disk array and server processor responsive to requests for reading and writing data from and to the disk array. The production server 12a may communicate with a variety of other local devices (not shown) generating or using large amounts of data.

The production server 12a communicates through a firewall 14a with a high-speed network interface 16a that will be discussed in greater detail below. The firewall 14a may operate at ISO network, transport, and application layers to analyze data received over an ethernet connection 18. In one example, the data may be transmitted using the Network File System (NFS) protocol implementing a distributed file system. NFS is available from and managed by the Internet Engineering Task Force (IETF).

As is understood in the art, the firewall 14a will provide for review of TCP packets against a set of security rules intended to detect and or block malware or spam and may be state-full or state-less. Typically, the firewall 14 will have a throughput of much less than 50 Gb per second.

The high-speed network interface 16a may communicate with the Internet 20 using Transmission Control Protocol (TCP) over a variety of media including but not limited to copper conductors, fiber optic cables, and wireless transmission technologies. As will be discussed below, this communication can be conducted at speeds in excess of 50 Gb per second and typically greater than 100 Gb. Generally, the transmission distance 22 spanned by the Internet 20 will be greater than 1 mile and typically greater than 500 miles.

At a destination end, a second high-speed network interface 16b receives the TCP packets at a rate of at least 50 Gb per second and typically greater than 100 Gb per second. This data may then be relayed through a second firewall 14b to a second production server 12b which may distribute this data locally with other devices (not shown) using that data.

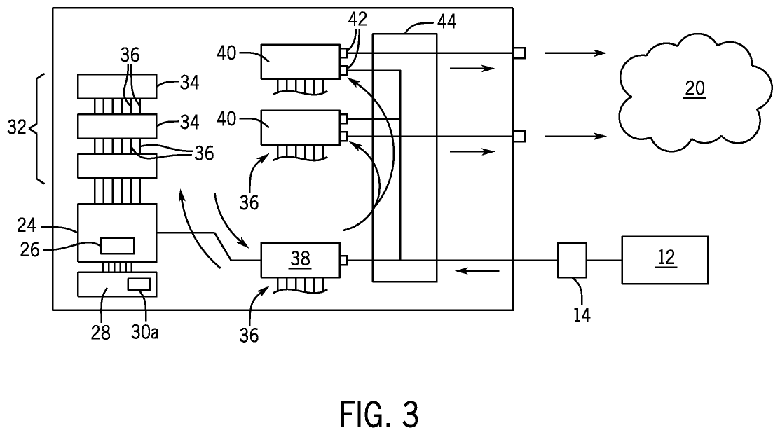

Referring now to FIGS. 2 and 3, the high-speed network interface 16 may generally provide a CPU having one or more processors 24 attached to a motherboard 26 of conventional design providing communication and logic between the processors 24 and various other components to be discussed below. The processors 24 may be standard von Neumann processors, for example, being superscalar processors with speculative execution, and providing one or more levels of cache 26 communicating with a bank of dynamic random access memory 28 on the motherboard 26 that may hold a stored program 30a.

The processors 24 may communicate with a bank 32 of solid-state drives 34, for example, as commercially available from Intel Corporation under the trade name Optane and together providing over 500 GB of storage or more. The solid-state drives 34 may communicate with the processor over a Peripheral Component Interconnect Express (PCIe) bus 36 employing the Nonvolatile Memory Express (NVMe) protocol. Generally this bank 32 will provide both a high-speed burst buffer, to be discussed below, and storage for an operating system integrating the components of the motherboard such as the Linux operating system, an open source program available from a variety of sources. Communication over the PCIe bus is moderated by the operating system executing on the processors 24.

The processor 24 may also communicate with a standard ethernet interface card 38, for example, also attached to the PCIe bus 36 for control and communication with the processors 24 under the control of the operating system and processors 24.

The motherboard 27 may also support one or more Data Processing Units (DPU's) 40 being special purpose processors for data transfer integrated with high-speed ethernet network interface circuitry. These DPUs 40 may also be connected to the PCIe bus 36 for control and communication with the processors 24; however, during operation, they may execute largely independent of the operating system and processors 24 after configuration. A DPU suitable for use with the present invention is commercially available from NVIDIA Corporation under the trade name Bluefield-3 DPU and provides an integrated network interface with the speed of over 300 gigabits per second through multiple dedicated ethernet ports 42. The DPUs 40 may be programmable to implement Nonvolatile Memory Express over Fabric (NVMe-OF) protocol over TCP (running at the transport, session, and presentation layers) to be compatible with the Internet 20 infrastructure when communicating over the Internet 20.

A separate high-speed ethernet switch 44 may communicate with each of the ports of the ethernet interface 38 and the DPUs 40. A high-speed ethernet switch 44 suitable for this purpose is available from NVIDIA under the trade name of Spectrum X and provides a transmission speed in excess of 400 Gb/s. Such switches provide routing of ethernet packets according packet addresses as is well understood in the art.

It will be understood that the motherboard 26 and processors 24 provide an architecture under the control of an operating system using the processors 24 in a timesharing, multitasking manner to establish internal data communication with components on the PCIe bus 36 and the dynamic random access memory 28.

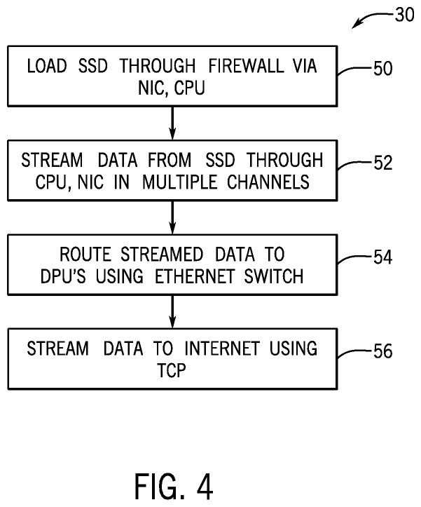

Referring now to FIGS. 3 and 4, a program 30 is implemented in distributed fashion by the processor 24 (as program 30a) and the DPUs 40. As indicated by process block 50, in a first step the solid-state drives 34 are loaded from the production server 12 through the firewall 14a which communicates with the ethernet interface 38 to provide data to the processor 24. This data is then distributed along the PCIe bus 36 to the various solid-state drives 34 of the bank 32. This process occurs at a relatively low transmission rate and thus is compatible with the limited transmission speeds of the production server 12 and the firewall 14a and will generally be much less than 50 GB per second. The data may be transferred using NFS (residing at the application layer) via TCP over the ethernet.

As indicated by process block 52, once sufficient data is buffered in the bank 32, it may be transmitted at high speed over the Internet by moving this data from the drives 34 moderated by the operating system executing on the processor 24 to the ethernet interface 38. The processors 24 may be dedicated to this task to perform this operation at high speed with minimal interruption by the operating system or the need to share internal communication channels with uninvolved components.

The output of the ethernet interface 38 may be received by the high-speed ethernet switch 44 to provide a high-speed connection to inputs of the DPUs 40. Generally the data will be shared between the DPUs to permit multiple channels of communication over the Internet 20 per process block 54. It will be appreciated that the number of DPUs 40 may be scaled arbitrarily for increased transmission rate performance and that the DPUs may be contained on separate motherboards relying on the high-speed Internet switch 44 for interconnection.

As indicated by process block 56, the DPUs 40, upon receiving data, immediately begin streaming the data to the high-speed ethernet switch 44 to a connection directly to the Internet 20, for example, over different ports, with minimal buffering in an internal dynamic random access memory of the DPUs 40. The DPUs 40 are programmed to handle the necessary protocol for converting the data received under NFS into TCP packets employing the NVMe-oF protocol.

At the receiving end of the system 10, the processes of process blocks 50-56 are repeated in reverse order with received data by the DPUs 40 decoded from NVMe-oF to NFS by the high-speed network interface 16b and then routed through its ethernet interface 38 via the associated high-speed ethernet switch 44 and its processors 24 to the associated bank 32. This data may then be transmitted from the bank 32 through the processors 24 and the ethernet interface 38 through the firewall 14b to the production server 12.

Certain terminology is used herein for purposes of reference only, and thus is not intended to be limiting. For example, terms such as “upper”, “lower”, “above”, and “below” refer to directions in the drawings to which reference is made. Terms such as “front”, “back”, “rear”, “bottom” and “side”, describe the orientation of portions of the component within a consistent but arbitrary frame of reference which is made clear by reference to the text and the associated drawings describing the component under discussion. Such terminology may include the words specifically mentioned above, derivatives thereof, and words of similar import. Similarly, the terms “first”, “second” and other such numerical terms referring to structures do not imply a sequence or order unless clearly indicated by the context.

When introducing elements or features of the present disclosure and the exemplary embodiments, the articles “a”, “an”, “the” and “said” are intended to mean that there are one or more of such elements or features. The terms “comprising”, “including” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

References to “a microprocessor” and “a processor” or “the microprocessor” and “the processor,” can be understood to include one or more microprocessors that can communicate in a stand-alone and/or a distributed environment(s), and can thus be configured to communicate via wired or wireless communications with other processors, where such one or more processor can be configured to operate on one or more processor-controlled devices that can be similar or different devices. Furthermore, references to memory, unless otherwise specified, can include one or more processor-readable and accessible memory elements and/or components that can be internal to the processor-controlled device, external to the processor-controlled device, and can be accessed via a wired or wireless network.

It is specifically intended that the present invention not be limited to the embodiments and illustrations contained herein and the claims should be understood to include modified forms of those embodiments including portions of the embodiments and combinations of elements of different embodiments as come within the scope of the following claims. All of the publications described herein, including patents and non-patent publications, are hereby incorporated herein by reference in their entireties.

To aid the Patent Office and any readers of any patent issued on this application in interpreting the claims appended hereto, applicants wish to note that they do not intend any of the appended claims or claim elements to invoke 35 U.S.C. 112(f) unless the words “means for” or “step for” are explicitly used in the particular claim.

What we claim is:

1. A high-speed data transfer architecture comprising:
an ethernet switch communicating with the Internet;
at least one network processor communicating with the ethernet switch;
an ethernet interface communicating with the ethernet switch;
a bank of multiple solid-state drives;
a processor communicating with the bank of multiple solid-state drives and the ethernet network interface; and
the processor, ethernet interface, and network processors operating to execute a stored program to:
(a) receive data from a production server through the ethernet switch, ethernet interface, and processor for storage in the solid-state drives at a first data rate;
(b) transmit the data from the solid-state drives through the processor and ethernet interface to the ethernet switch for receipt by the network processors; and
(c) transmit from the network processors to the Internet at a data rate in excess of 50 Gb per second.

2. The high-speed data transfer architecture of claim 1 wherein the bank includes at least two network processors each communicating with the ethernet switch for simultaneous transmission to the Internet to provide the data rate.

3. The high-speed data transfer architecture of claim 1 wherein the ethernet switch has a transmission capacity of greater than 100 Gb per second.

4. The high-speed data transfer architecture of claim 1 wherein the solid-state drives have a capacity of at least 500 GB.

5. The high-speed data transfer architecture of claim 4 wherein the solid-state drives receive data using the NVMe protocol.

6. The high-speed data transfer architecture of claim 5 wherein the processor communicates with the solid-state drives over a Peripheral Component Interconnect Express (PCIe) bus.

7. The high-speed data transfer architecture of claim 1 wherein the communication between the ethernet interface and the processor and the ethernet interface and the ethernet switch employs the Network File System (NFS) protocol.

8. The high-speed data transfer architecture of claim 1 wherein the processor is a von Neumann CPU with an internal cache memory of static random access memory communicating in a memory hierarchy with dynamic random access memory holding at least a portion of the program.

9. The high-speed data transfer architecture of claim 1 wherein the network processors are data processing units integrating network interface hardware.

10. The high-speed data transfer architecture of claim 1 further including a firewall and the production server and wherein the processor and ethernet interface further operate to execute the stored program to receive the data via the firewall from the Production server over ethernet.

11. A method of high-speed data transfer using:
an ethernet switch communicating with the Internet;
a bank of at least one network processor communicating with the ethernet switch;
an ethernet interface communicating with the ethernet switch;
a processor communicating with multiple solid-state drives and the ethernet network interface; and
a method including the steps of:
(a) receiving data from a production server through the ethernet switch, ethernet interface, and processor for storage in the solid-state drives at a first data rate;
(b) transmitting the data from the solid-state drives through the processor and ethernet interface to the ethernet switch for receipt by the network processors; and
(c) transmitting from the network processors to the Internet at a data rate in excess of 50 Gb per second.
